(19) United States
(12) Patent Application Publication
(10) Pub. No.: US 2026/0087659 A1
(43) Pub. Date: Mar. 26, 2026

(54) TRACKING RATE AND VOLUME OF LIQUID CONSUMPTION

(71) Applicant: Apple Inc., Cupertino, CA (US)

(72) Inventors: Max Zadeh, San Jose, CA (US); Shubham Agrawal, Sunnyvale, CA (US)

(21) Appl. No.: 19/316,412

(22) Filed: Sep. 2, 2025

Related U.S. Application Data
(60) Provisional application No. 63/698,859, filed on Sep. 25, 2024.

(51) Int. Cl. G06T 7/62; G06N 20/00

(52) U.S. Cl. CPC G06T 7/62; G06N 20/00

(57) ABSTRACT

Various implementations disclosed herein include devices, systems, and methods that determine a rate and volume of liquid being consumed by a user based on user attributes determined from wearable device sensor data. For example, a process may obtain sensor data from at least one sensor on a wearable device. The sensor data may correspond to activities of a user wearing the wearable device while consuming a liquid during a liquid consumption event. Based on the sensor data, the process may further determine a liquid consumption type associated with the activity of the user. Based on the sensor data and the liquid consumption type, the process may further determine a consumption rate and a consumption volume associated with the activity. Optionally, feedback may be provided to the user based on the determined consumption rate and consumption volume.

### CROSS REFERENCE TO RELATED APPLICATIONS

This application claims the benefit of U.S. Provisional Application Ser. No. 63/698,859 filed Sep. 25, 2024, which is incorporated herein in its entirety.

### TECHNICAL FIELD

The present disclosure generally relates to systems, methods, and devices that determine a rate and volume of liquid being consumed by a user for liquid consumption tracking.

### BACKGROUND

Existing user monitoring and feedback techniques may be improved with respect to accuracy and efficiency.

### SUMMARY

Various implementations disclosed herein include devices, systems, and methods that are configured to determine a rate and/or volume of liquid being consumed by a user based on user attributes determined from wearable device sensor data. For example, during user consumption of a liquid, sensor data is obtained and processed via a liquid consumption model (e.g., a machine learning (ML) model, a rule-based, deterministic model, etc.) to determine a rate and volume of liquid being consumed by the user. In some implementations the sensor data may be obtained and processed in real time. In some implementations, the liquid consumption model may be customized to the user during an enrollment process.

In some implementations, the sensor data may include audio data (e.g., from a microphone) comprising audible sounds (e.g., sipping sounds, gulping sounds, swallowing sounds, etc.) produced by the user during a liquid consumption event associated with consumption of a liquid.

In some implementations, the sensor data may include inertial measurement unit (IMU) data representing head movements (e.g., a head pose, head movement in an upward or downward direction, etc.) of the user during a liquid consumption event.

In some implementations, the sensor data may include audio accelerometer data produced from body portion movements or vibrations (e.g., from bone and muscle conducting movements) of the user during the liquid consumption event.

In some implementations, the sensor data may include vision sensor data depicting the consumable liquid, the container, environmental context, etc.

In some implementations, the sensor data may include biometric data such as, inter alia, data representing a heartrate or blood pressure of the user.

In some implementations, the determined rate and volume of liquid being consumed by a user may be used to provide feedback to the user such as, for example, enabling the user to track a liquid consumption rate, volume, and information derived thereof such as calorie intake during a specified timeframe (e.g., per hour, per day, etc.).

In some implementations, the aforementioned feedback may be based on additional information associated with a liquid consumption event. For example, feedback may be based on drinking techniques such as, inter alia, a normal drinking technique, a gulping technique, a sipping technique, using a straw, etc.

In some implementations, the aforementioned feedback may be based on a specific type or types of liquid may include any type of consumable liquid such as, inter alia, water, soda, coffee, tea, any clear liquid, a smoothie, etc.

In some implementations, the aforementioned feedback may be based on a liquid color such as clear, opaque, etc.

In some implementations, the aforementioned feedback may be based on a liquid viscosity such as Pascal-second measurement of viscosity.

In some implementations, the aforementioned feedback may be based on liquid characteristics such as carbonated versus non-carbonated, hot versus cold, with ice cubes versus without ice cubes, etc.

In some implementations, the aforementioned feedback may be based on environmental context such as a type of environment, a time of day, etc.

In some implementations, a wearable device has a processor (e.g., one or more processors) that executes instructions stored in a non-transitory computer-readable medium to perform a method. The method performs one or more steps or processes. In some implementations, the wearable device obtains sensor data from at least one sensor on the wearable device. The sensor data corresponds to activity of the user wearing the wearable device while consuming a liquid during a liquid consumption event. In some implementations, based on the sensor data, a liquid consumption type associated with the activity of the user is determined. In some implementations, based on the sensor data and the liquid consumption type, a consumption rate and a consumption volume associated with the activity is determined and optional feedback may be provided to the user based on the consumption rate and consumption volume.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an exemplary electronic device operating in a physical environment, in accordance with some implementations.

FIGS. 2A and 2B illustrate views representing an enrollment process for generating a model used to determine and document a rate and type of liquid consumption by a user, in accordance with some implementations.

FIGS. 2C, 2D, and 2E illustrate views representing a process for determining a rate and volume of liquid being consumed by a user based on user attributes determined from wearable device sensor data, in accordance with some implementations.

FIG. 3 illustrates an example environment for implementing an enrollment process for determining a rate and volume of liquid being consumed by a user based on user attributes determined from wearable device sensor data, in accordance with some implementations.

FIG. 4 is a flowchart representation of an exemplary method that determines a rate and volume of liquid being consumed by a user for liquid consumption tracking, in accordance with some implementations.

FIG. 5 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

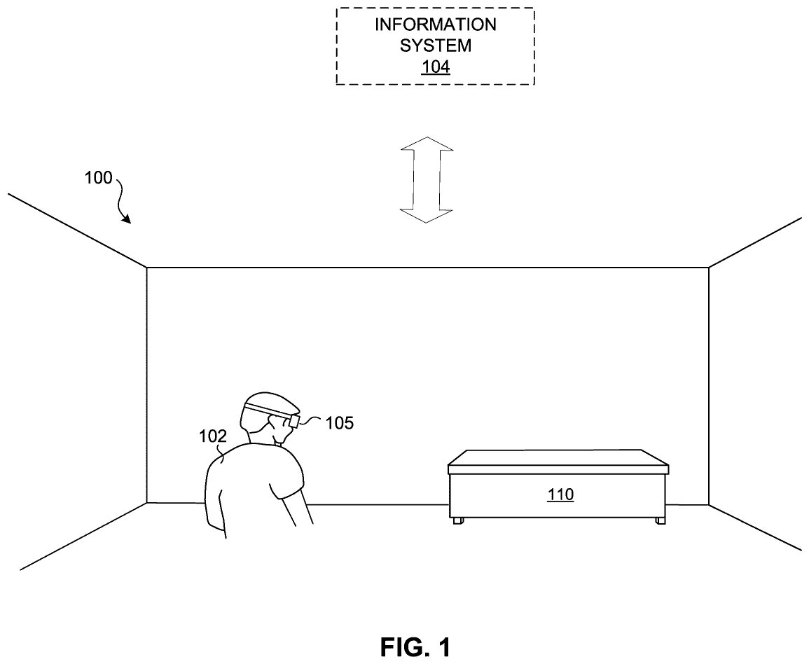

FIG. 1 illustrates an exemplary electronic device 105 operating in a physical environment 100 that may correspond to an extended reality (XR) environment. Additionally, electronic device 105 may be in communication with an information system 104 (e.g., a device control framework or network). In an exemplary implementation, electronic device 105 is sharing information with the information system 104. In the example of FIG. 1, the physical environment 102 is a room that includes physical objects such as a desk 110. The electronic device 105 may include one or more cameras, microphones, depth sensors, IMU sensors, audio accelerometer sensors or other sensors that can be used to capture information about and evaluate the physical environment 100 and the objects within it, as well as information about the user 102 of electronic device 105. The information about the physical environment 100 and/or user 102 may be used to provide visual and audio content, identify objects and actions (of the user), the physical environment 100, and/or to identify the current location of the physical environment 100 and/or the location of the user within the physical environment 100.

In some implementations, views of an extended reality (XR) environment may be provided to one or more participants (e.g., user 102 and/or other participants not shown) via electronic device 105 (e.g., a wearable device such as an HMD). Such an XR environment may include views of a 3D environment that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system associated with the XR environment, which may correspond to a 3D coordinate system of the physical environment 100.

In some implementations, a wearable electronic device such as an HMD (e.g., device 105) may be configured to obtain sensor data from a sensor(s) on the wearable device. In some implementations, the sensor data corresponds to attributes of a user (e.g., user 102) wearing the wearable device while consuming a liquid (from a container) during a liquid consumption event. For example, attributes include, inter alia, sounds, head movements (e.g., a head pose, head movement in an upward or downward direction, etc.), vibrations (e.g., from bone and muscle conducting movements), biometric data (e.g., a heartrate, blood pressure, etc.), etc. of the user while consuming the predetermined amount of liquid with respect to the different liquid consumption techniques. Likewise, the sensor data may additionally depict (e.g., via images) the liquid, a container, environmental context, etc. The sensors may include, audio sensors, IMU sensors, image sensors, audio accelerometer sensors, etc. Likewise, timing sensors may be utilized to capture timing information, e.g., via a timing application on the wearable device.

In some implementations, a consumption rate and a consumption volume associated with consuming the liquid may be determined based on the sensor data. For example, determining a consumption rate and a consumption volume associated with consuming the liquid may include inputting sensor data into a ML model.

In some implementations, determining a consumption rate may be based on user attributes used to predict sips, sip amounts, gulps, gulp amounts, any combination thereof, etc.

In some implementations, determining a consumption volume may be based on image data identifying a container size or geometry such as, inter alia, a glass diameter and height or surface level of liquid in a container before and after a consumption event.

In some implementations, feedback is provided to the user based on the consumption rate and consumption volume. In some implementations, feedback may summarize information across multiple liquid consumption events. For example, feedback may provide a total daily liquid consumption volume, average liquid consumption rate, average daily calories from liquid consumed, etc.

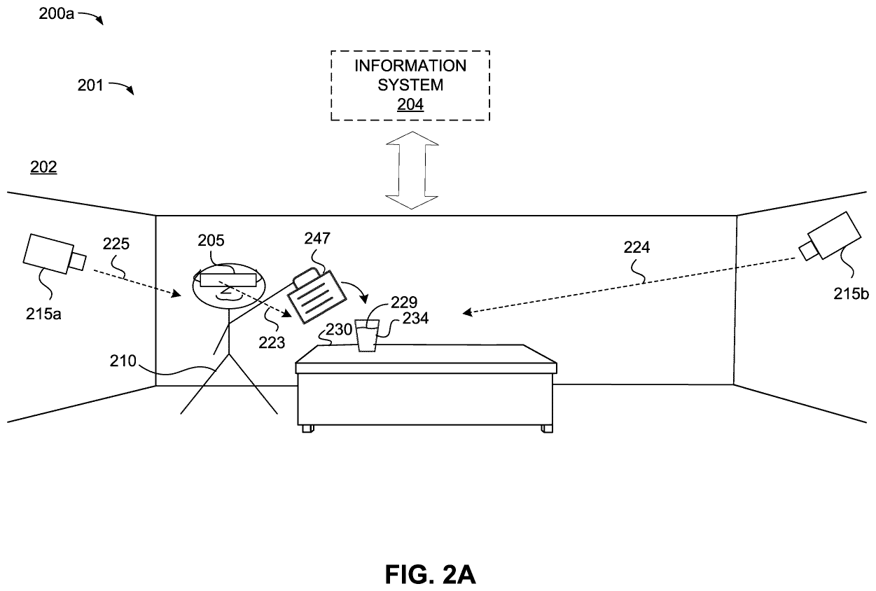

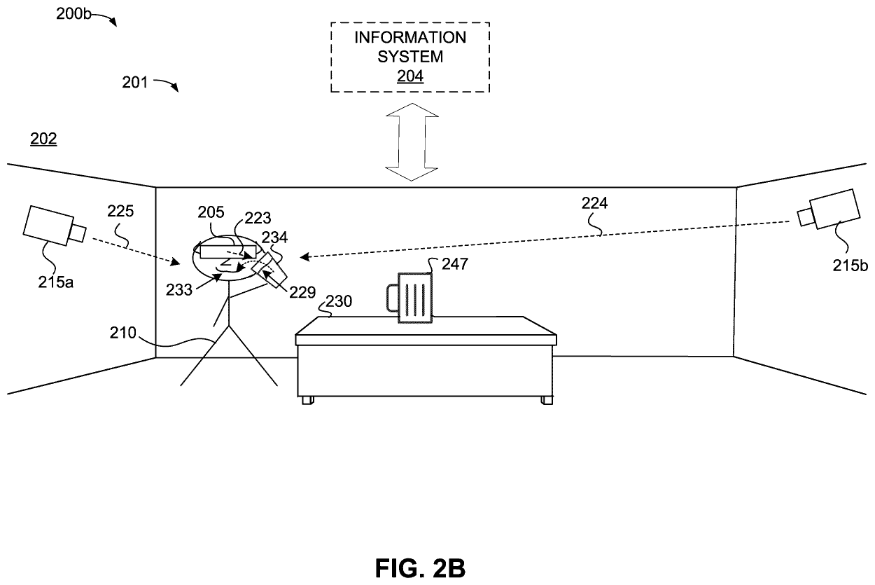

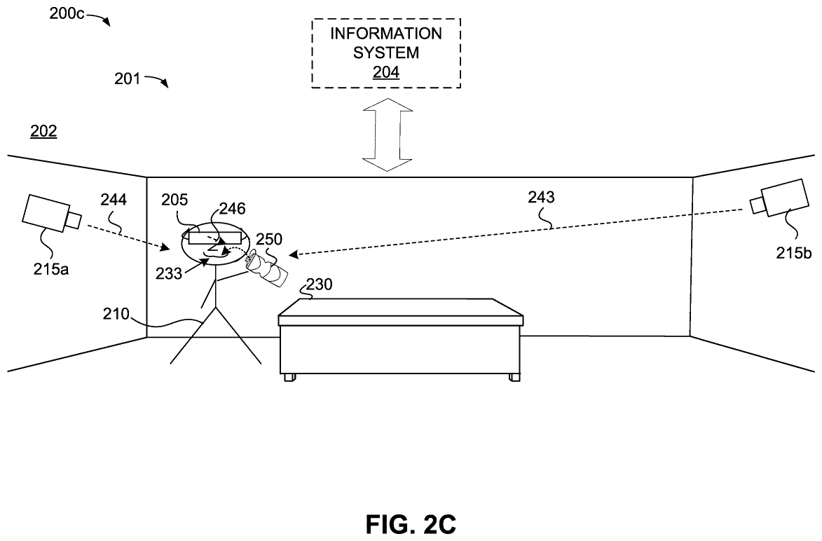

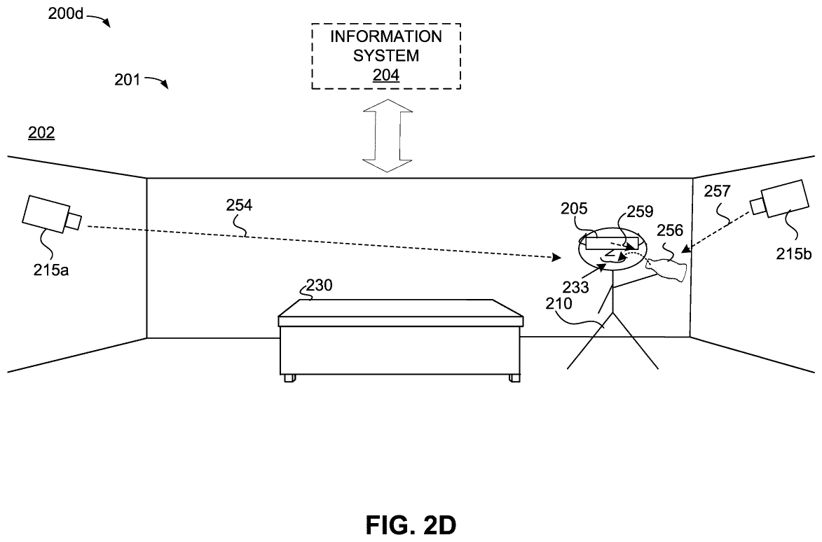

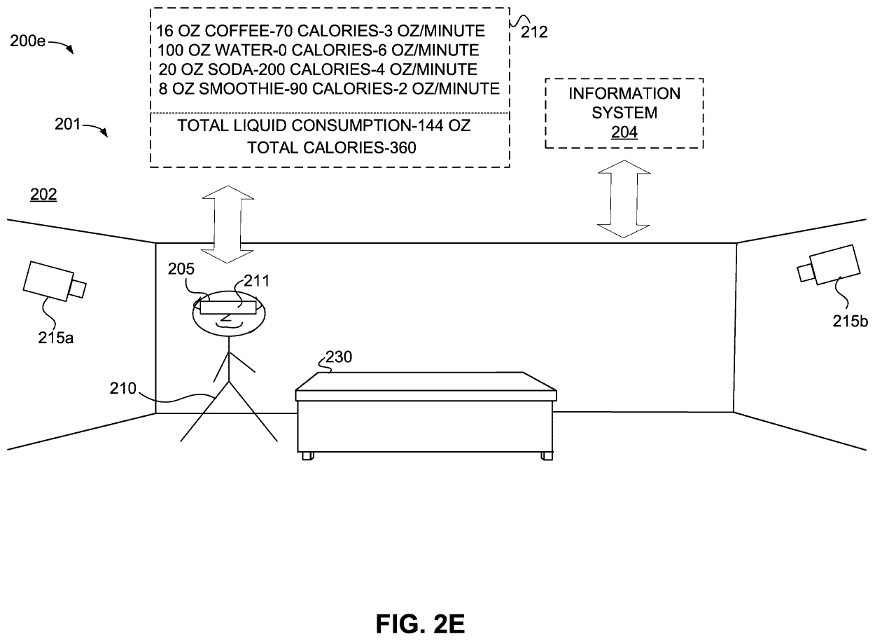

FIGS. 2A and 2B illustrate views 200a and 200b representing an enrollment process for generating a personalized liquid consumption model used to determine and document characteristics (e.g., consumption rate, consumption amount, liquid consumption technique, liquid identification, etc.) by a user 210, in accordance with some implementations.

FIG. 2A illustrates view 200a representing an example environment 201 comprising exemplary electronic devices 205 (e.g., a wearable device such as an HMD), 215a, and 215b operating in a physical environment 202 during a first time period. Additionally, example environment 201 may include an information system 204 (e.g., a framework, server, controller or network) in communication with one or more of the electronic devices 205, 215a, and 215b. In an exemplary implementation, electronic devices 205, 215a, and 215b are communicating with each other and an intermediary device such as information system 204. In some implementations, electronic devices 205, 215a, and 215b may include HMDs, stand-alone video camera devices, wall-mounted camera devices, wireless headphones that include image and audio sensors, etc. each comprising multiple different sensor types.

In some implementations, physical environment 202 includes a user 210 wearing electronic device 205. In some implementations, electronic device 205 comprises a wearable device (e.g., a head mounted display (HMD) configured to present views of an extended reality (XR) environment (e.g., a 3D scene), which may be based on the physical environment 202, and/or in some implementations include added content such as virtual objects.

In the example of FIG. 2A, the physical environment 202 may be a room that includes physical objects such as a desk 230, a container 247, and a container 234. For example, container 247 may be a pitcher, a bottle, a carafe, a decanter, etc. Likewise, container 234 may be a cup, a glass, a mug, a travel container, etc. In some implementations, the physical environment 202 is a part of an XR environment presented by, for example, electronic device 205.

In some implementations, each electronic device 205, 215a, and 215b may include one or more sensors (e.g., directed towards user 210 via directions 223, 224, and 225) such as, inter alia, cameras, microphones, depth sensors, motion sensors, optical sensors, IMU sensors, image sensors, audio accelerometer sensors, or other sensors, etc. that may be used to capture information about and evaluate the physical environment 202 and/or an XR environment and the objects within it, as well as information about user 210. Each electronic device 205, 215a, and 215b may be configured to detect sounds, head movements, vibrations, biometrics, etc. of the user.

In some implementations, view 200a represents an initialization of an enrollment process for generating a model used to determine and document a rate and type of liquid consumption by a user.

Upon activation, the enrollment process may initially be configured to instruct user 210 (using a wearable device such as electronic device 205) to add a predetermined amount (e.g., 2 oz, 4 oz, etc.) of a specific type of liquid (e.g., water, soda, coffee, smoothie, etc.) to container 234. In response, the user 210 may use container 247 (e.g., comprising the specified type of liquid) to add the predetermined amount of liquid to container 234. For example, the liquid may be added to the container 234 until the liquid reaches a specified level 229 representing the specified amount such as, for example, 12 fluid oz.

In some implementations, during the process for adding the predetermined amount of liquid to the container, sensors of each electronic device 205, 215a, and 215b (e.g., cameras, microphones, depth sensors, motion sensors, optical sensors, IMU sensors, image sensors, audio accelerometer sensors, etc.) may be activated to monitor and track the process. For example, the sensors of each electronic device 205, 215a, and 215b may be configured to monitor an amount, a color, a liquid viscosity, etc. of the liquid to use an input for personalizing a liquid consumption model, a rule-based, deterministic model, or a machine learning (ML) model to subsequently predict characteristics of liquid consumption events. Likewise, the sensors of each electronic device 205, 215a, and 215b may be configured to monitor multiple liquid (and solid) types being added to container 234 to determine differing ingredients being added to container 234 use as input for personalizing a liquid consumption model, a rule-based, deterministic model, or an ML model to subsequently predict characteristics of liquid consumption events. For example, the sensors of each electronic device 205, 215a, and 215b may detect amounts of coffee, creamer, and sugar being added to container 234 to personalize the ML model to subsequently determine an amount of liquid and associated calories that are being consumed by user 210.

Subsequent to the predetermined amount of the specified liquid type being added to container 234, user 210 may be instructed to consume the predetermined amount of liquid using multiple, different liquid consumption techniques as described with respect to FIG. 2B, infra.

FIG. 2B illustrates view 200b of example environment 201 during a second time period occurring subsequent to the first time period illustrated in view 200b of FIG. 2A, in accordance with some implementations. View 200b illustrates exemplary electronic devices 205, 215a, and 215b operating in physical environment 202 subsequent to a predetermined amount of a specified liquid type being added to container 234 as described with respect to FIG. 2A.

View 200b represents the enrollment process instructing user 210 to consume (e.g., by tipping container 234 towards mouth 233 of user 210) the predetermined amount of liquid (via container 234) using multiple, different liquid consumption techniques associated with consuming the liquid at different speeds. For example, the user may be instructed to consume the predetermined amount by using a normal liquid consumption technique, a gulping technique, a sipping technique, using a straw, etc.

In some implementations, view 200b illustrates that while the user is consuming the liquid, sensor data is obtained from sensors of electronic device 205, 215a, and/or 215b. The sensor data may include audio data (e.g., from a microphone) comprising audible sounds (e.g., sipping sounds, gulping sounds, swallowing sounds, etc.) produced by the user during a liquid consumption event.

In some implementations, the sensor data may include IMU data representing head movements of user 210 during a liquid consumption event. For example, sensor data representing a head pose, head movement in an upward or downward direction, etc. may be obtained from sensors (of any of devices 205, 215a, and/or 215b) such as image sensors, IMU sensors, etc.

In some implementations, the sensor data may include audio accelerometer data produced from body portion movements of the user 210 during the liquid consumption event. For example, the sensor data may include data describing vibrations from bone and muscle conducting movements, etc.

In some implementations, the sensor data may include vision sensor data depicting the consumable liquid and the specified level 229 of the liquid (in container 234), the container 234, environmental context (e.g., associated with physical environment 202), etc.

In some implementations, the sensor data may include biometric data such as data representing a heartrate, a temperature, blood pressure, etc. of the user 210.

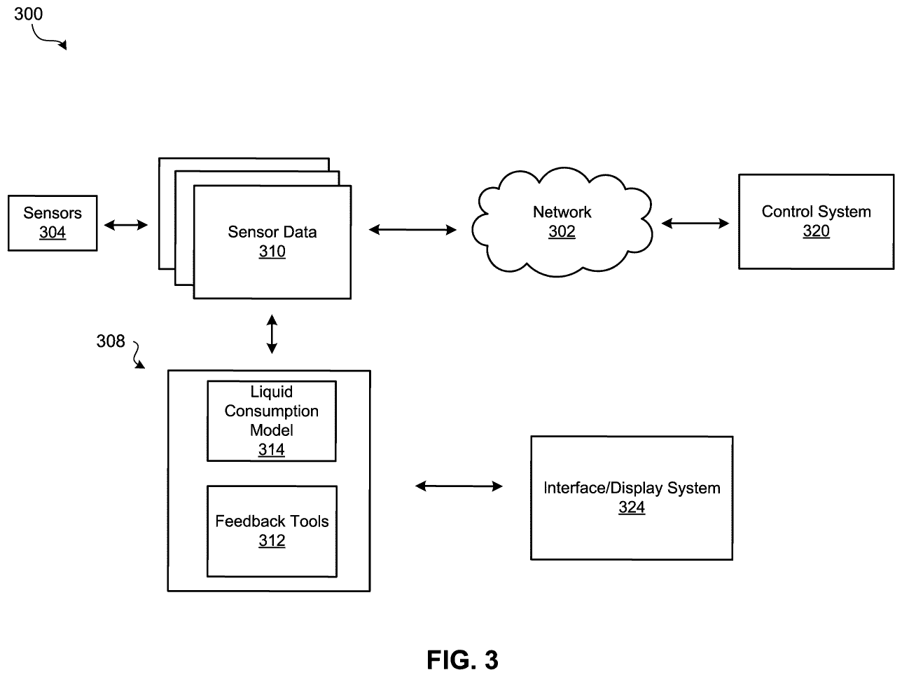

In some implementations, sensor data obtained while the user is consuming the liquid is used to personalize or train an ML model or a rule-based, deterministic model to use subsequent sensor data (e.g., during a usage process) to predict characteristics of consumption events involving the user as further described with respect to FIG. 3, infra. For example, characteristics of consumption events may include, inter alia, a liquid type, an amount of liquid consumed, a liquid consumption technique, a mixture of differing liquid and solids (e.g., coffee creamer, and sugar), liquid consumption behavior, etc.

FIGS. 2C, 2D, and 2E illustrate views 200c, 200d, and 200e representing a process for determining/tracking a rate and volume of liquid being consumed by a user 210 based on user attributes determined from wearable device sensor data, in accordance with some implementations. The process illustrated with respect to FIGS. 2C, 2D, and 2E occurs subsequent to the initial enrollment process described with respect to FIGS. 2A and 2B. Likewise, the process illustrated with respect to FIGS. 2C, 2D, and 2E may occur in a same physical environment as the enrollment process (e.g., physical environment 202 as illustrated in FIG. 2C, 2D, or 2E) or different physical environments (e.g., different rooms, different physical locations, within a vehicle, while exercising at a fitness center, etc.).

FIG. 2C illustrates view 200c representing example environment 201 (as described with respect to FIGS. 2A and 2B) comprising exemplary electronic devices 205 (e.g., a wearable device such as an HMD), 215a, and 215b operating in physical environment 202 during a first time period subsequent to the initial enrollment process.

In the example of FIG. 2C, the physical environment 202 is a room that includes physical objects such as desk 230 and a container 250. For example, container 250 may be a cup, a glass, a mug, a travel container, a bottle, etc.

In some implementations, each electronic device 205, 215a, and 215b may include one or more sensors (e.g., directed towards user 210 via directions 244, 246, and 243) such as, inter alia, cameras, microphones, depth sensors, motion sensors, optical sensors, IMU sensors, image sensors, audio accelerometer sensors, or other sensors, etc. that may be used to capture information about and evaluate the physical environment 202 and/or an XR environment and the objects within it, as well as information about user 210. Each electronic device 205, 215a, and 215b may be configured to detect sounds, head movements, vibrations, biometrics, etc. of the user.

View 200c represents a process (occurring subsequent to the enrollment process described with respect to FIGS. 2A and 2B) to determine a rate and volume of liquid (within container 250) being consumed by user 210 (during a liquid consumption event) based on user attributes determined from analysis of sensor data obtained from the one or more sensors of at least one of electronic device 205, 215a, and 215b with respect to enrollment data associated with a volume consumed with each sip or gulp via cup or through a straw.

The process may be initiated when user 210 begins to consume (e.g., by tipping container 250 towards mouth 233 of user 210) the liquid (from container 250) using one or multiple, different liquid consumption techniques associated with consuming the liquid at different speeds. For example, the user may consume the liquid from container 250 by using a normal consumption (e.g., drinking) technique, a gulping technique, a sipping technique, using a straw, any combination thereof, etc.

In some implementations, the process may be initiated based on IMU data, for example, representing a head of user 210 being tilted at an angle exceeding a threshold angle. In some implementations, the process may be initiated based on visual data such as, for example, image data indicating that container 250 is located at a position that is within a threshold distance of a face of user 210, indicating that the user 210 is likely going to consume liquid inside of the container 250. In some implementations, it may be detected that the container 250 is within a threshold distance to the user 210 but the users head is not in a tilted position. In this instance, it may be determined that the user 210 is drinking out of a straw; and the process may be initiated based on audible signals.

In some implementations, in response to the process being triggered, the initiating device (e.g., electronic device 205, 215a, and/or 215b) may be configured to recall frames of video to determine a type of liquid is being consumed. Likewise, the initiating device (e.g., electronic device 205, 215a, and/or 215b) may be configured to recall frames of video to determine an appearance of the liquid and/or a label on container 250 (e.g., can/cup) or a label located on a carton or bottle that was used to pour its contents into the container 250 currently being used (by user 210) to consume a liquid, In some implementations, the initiating device (e.g., electronic device 205, 215a, and/or 215b) may be configured to recall frames of video to determine a viscosity of a liquid is being consumed which may affect an amount of liquid consumed for each liquid consumption technique. For example, lower viscous liquids may result in more volume consumed with each consumption event and higher viscous liquids may result in less volume consumed with each consumption event.

In some implementations, view 200c illustrates that while user 210 is consuming the liquid from container 250, sensor data is obtained from sensors of electronic device 205, 215a, and/or 215b. The sensor data may include audio data (e.g., from a microphone) comprising audible sounds (e.g., sipping sounds, gulping sounds, swallowing sounds, etc.) produced by user 210 while consuming the liquid.

In some implementations, the sensor data may include IMU data representing head movements of user 210 while consuming the liquid. For example, sensor data representing a head pose, head movement in an upward or downward direction, etc. may be obtained from sensors (of any of devices 205, 215a, and/or 215b) such as image sensors, IMU sensors, etc.

In some implementations, the sensor data may include audio accelerometer data produced from body portion movements of the user 210 while consuming the liquid. For example, the sensor data may include data describing vibrations from bone and muscle conducting movements, etc.

In some implementations, the sensor data may include image sensor data depicting the consumable liquid and a size or geometry of container 250 such as, for example, a diameter of container 250 and/or a height of liquid in container 250 prior and subsequent to user 210 consuming the liquid.

In some implementations, the sensor data may include biometric data such as data representing a heartrate, a temperature, blood pressure, etc. of the user 210 while consuming the liquid.

In some implementations, the sensor data is processed (e.g., in real time) via a liquid consumption model (e.g., customized to user 210 during an enrollment process) to determine the rate and/or volume of liquid being consumed by the user during a liquid consumption event. An output of the ML model processing the sensor data provides information that may be used to provide feedback data to the user. For example, the feedback data may enable user 210 to track a liquid consumption rate, a liquid consumption volume, and any additional information derived thereof such as, inter alia, caloric intake during a specified timeframe (e.g., per hour, per day, etc.), etc. Likewise, the feedback data may summarize information across multiple liquid consumption events thereby providing a total daily liquid intake volume, average liquid consumption rate, average daily calories from consumption of liquid, etc.

In some implementations, the feedback data may be based on additional information associated with a single or multiple liquid consumption events. For example, a liquid consumption type (e.g., sipping, gulping, normal, etc.), a liquid type (e.g., water, tea, soda, etc.), a liquid color (e.g., clear, opaque), a liquid viscosity (e.g., Pascal-second), liquid characteristics (e.g., carbonated, a mixture of differing liquids and solids (e.g., coffee, creamer, and sugar), an environmental context (e.g., type of environment, time of day, etc.), etc.

In some implementations, the device (e.g., electronic device 205, 215a, and/or 215b) may be configured to determine or track the liquid consumption type (e.g., a sip or a gulp out of cup while tilting a head back, a sip or gulp out of a straw, etc.) being performed by user 210 by, for example, using IMU data to determine if user 210 is drinking directly from a cup and then using audio to determine if the liquid consumption type is a sip or a gulp and if a head tilt is not detected, then an audio signal may be used to first trigger tracking of volume of liquid being consumed while simultaneously using IMU data to confirm that the head of user 210 is not tilted. Additionally, visual data may be used, for example, to confirm presence of a straw.

FIG. 2D illustrates view 200d representing example environment 201 comprising exemplary electronic devices 205, 215a, and 215b operating in physical environment 202 during a second time period subsequent to the to the first time period illustrated in view 200c.

In contrast to view 200c of FIG. 2C, view 200d of FIG. 2D represents a process to determine a rate and/or volume of liquid (within an additional container 256) being consumed by user 210 (during an additional liquid consumption event) based on user attributes determined from analysis of sensor data obtained from the one or more sensors of each electronic device 205, 215a, and 215b (directed towards user 210 via directions 259, 254, and 257) such as, inter alia, cameras, microphones, depth sensors, motion sensors, optical sensors, IMU sensors, image sensors, audio accelerometer sensors, or other sensors, etc. For example, view 200c of FIG. 2C may represent a first liquid consumption event (occurring during a first time period and related to a first activity such as exercise) corresponding to user 210 consuming water (e.g., 20 fluid oz) while view 200d of FIG. 2D may represent a second liquid consumption event (occurring during a second subsequent time period and resulted to a second activity such as watching TV, driving a car, computer related activities, etc.) corresponding to user 210 consuming soda (e.g., 16 fluid oz). Accordingly, sensor data representing the first and second liquid consumption events are processed via a liquid consumption model to generate feedback summarizing information across multiple liquid consumption events as further described with respect to FIG. 2E, infra.

FIG. 2E illustrates a view 200e representing presentation of a rate, volume, and calories corresponding to liquid consumed by user 210 during multiple liquid consumption events corresponding to the processes described with respect to FIGS. 2C and 2D.

In some implementations, subsequent to monitoring liquid consumption events and generating corresponding feedback information 212 related to the liquid consumption events, the corresponding feedback information 212 is presented to user via a display 211 of wearable device 205. In some implementations, wearable device 205 does not include a display. In this instance, corresponding feedback information 212 can be presented via another device, such as, inter alia, a mobile device, a tablet, a laptop, etc.

In some implementations, subsequent to monitoring liquid consumption events and generating corresponding feedback information related to the liquid consumption events, the corresponding feedback information 212 may be presented to user via a display of a device external to the wearable device 205 (e.g., a mobile device, a tablet, etc.). In some implementations, wearable device 205 does not include a display. In this instance, corresponding feedback information 212 can be presented via another device, such as, inter alia, a mobile device, a tablet, a laptop, etc.

In the example illustrated in view 200e, feedback information 212 includes a liquid type (e.g., coffee), a liquid amount (e.g., 16 oz), associated calories (e.g., 70 calories), and a liquid consumption rate (e.g., 3 oz/minute) for a plurality of liquid consumption events. Likewise, feedback information 212 may include a total liquid consumption (e.g., 144 oz) and total calories consumed (e.g., 360 calories) during a specified time period such as, for example, 24 hours.

FIG. 3 illustrates an example environment 300 for implementing a process for determining a rate and volume of liquid being consumed by a user based on user attributes determined from wearable device sensor data, in accordance with some implementations. The example environment 300 includes sensors 304 (e.g., sensors of electronic devices 205, 215a, and 215b FIGS. 2A-2E), sensor data 310, tools/software 308, a control system 320 (e.g., information system 104 of FIG. 1), and an interface/display system 324 that, in some implementations, communicates over a data communication network 302, e.g., a local area network (LAN), a wide area network (WAN), the Internet, a mobile network, or a combination thereof.

Tools/software 308 comprise an a liquid consumption model 314 (e.g., a machine learning (ML) model, a rule-based, deterministic model, etc.) and feedback tools 312.

In some implementations, example environment 300 is configured to enable sensors 304 (of the wearable device or within an environment) to be activated to detect and monitor liquid consumption (by a user) and resulting sensor data 310 corresponding to attributes of the user is obtained. For example, attributes of the user may include sounds, head movements, vibrations, etc. associated with the user wearing the wearable device while consuming a liquid during a liquid consumption event.

In some implementations, sensor data 310 may include audio data (e.g., from a microphone) comprising audible sounds (e.g., sipping sounds, gulping sounds, swallowing sounds, etc.) produced by the user during liquid consumption, IMU data representing head movements of the user during liquid consumption, audio accelerometer data produced from vibrations associated with bone and muscle conducting movements, vision sensor data depicting the consumable liquid and a level or depth of the liquid with respect to its container, biometric data such as data representing a heartrate, etc.

In some implementations, sensor data 310 is used as input into liquid consumption model 314 to determine a liquid consumption rate and a liquid consumption volume associated with consuming the liquid.

In some implementations, determining the liquid consumption rate may be based on the user attributes to predict sips, sip amounts, gulps, gulp amounts, etc. corresponding to a liquid consumption event.

In some implementations, determining the liquid volume may be based on image data identifying container size (e.g., of a container such as container 256 of FIG. 2D) such as, for example, a glass geometry/diameter and height of a liquid in the container prior and subsequent to a consumption event.

In some implementations, feedback may be provided to the user based on the liquid consumption rate and liquid consumption volume. For example, the feedback may be configured to summarize information across multiple liquid consumption events by, for example, providing a total daily liquid consumption volume, an average liquid consumption rate, average daily calories from liquid consumption, etc.

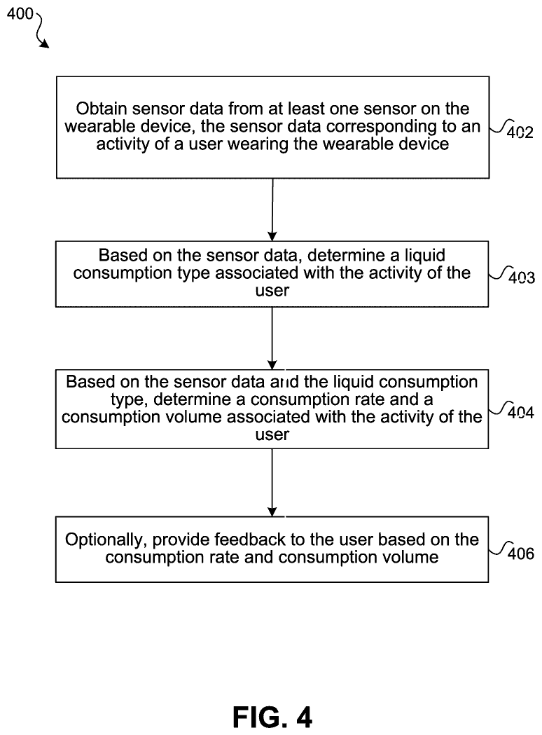

FIG. 4 is a flowchart representation of an exemplary method 400 that determines a rate and/or volume of liquid being consumed by a user for liquid consumption tracking, in accordance with some implementations. In some implementations, the method 400 is performed by a device(s), such as a tablet device, mobile device, desktop, laptop, HMD, server device, information system, wireless headphones with image and audio sensors, etc. In some implementations, the device has a screen for displaying images and/or a screen for viewing stereoscopic images such as a head-mounted display (HMD such as e.g., device 105 of FIG. 1). In some implementations, the method 400 is performed by processing logic, including hardware, firmware, software, or a combination thereof. In some implementations, the method 400 is performed by a processor executing code stored in a non-transitory computer-readable medium (e.g., a memory). Each of the blocks in the method 400 may be enabled and executed in any order.

At block 402, the method 400 obtains sensor data from at least one sensor on a wearable device. The sensor data corresponds to attributes of a user wearing the wearable device while consuming a liquid during a liquid consumption event. For example, sensor data corresponding to attributes of a user 102 wearing a wearable device 105 while consuming a liquid (from a container) during a liquid consumption event as described with respect to FIG. 1.

In some implementations, the attributes may include head movements of the user during the liquid consumption event. For example, head movements (a head pose, head movement in an upward or downward direction, etc.) of a user 210 while consuming the liquid as described with respect to FIG. 2C.

In some implementations, the attributes may include vibrations produced from body portion movements such as vibrations from bone and muscle conducting movements of the user during the liquid consumption event as described with respect to FIG. 2C.

In some implementations, the attributes may include biometric attributes (e.g., a heartrate, blood pressure, etc.) of the user during the liquid consumption event as described with respect to FIG. 2C.

In some implementations, sensor data may include audio data from a microphone as described with respect to FIG. 2C.

In some implementations, sensor data may include IMU data as described with respect to FIG. 2C.

In some implementations, sensor data may include audio accelerometer data as described with respect to FIG. 2C.

At block 403, based on the sensor data, a liquid consumption type being performed by a user may be determined, for example, by using IMU data to determine if the user is drinking directly from a cup and then using audio to determine if the liquid consumption type is a sip and/or a gulp and/or whether the user is tilting their head back or using a straw, which may change the rate/volume of liquid consumption for sipping or gulping as described with respect to, for example, FIG. 2c. For example, a liquid consumption type may be determined from the following scenarios: (a) a sip while a head is tilted head back, (b) a gulp while a head is tilted head back, (c) a sip with straw, and/or (d) a gulp with straw.

At block 404, based on the sensor data and the liquid consumption type, a consumption rate and a consumption volume associated with consuming the liquid may be determined or may be obtained as a result of an enrollment process. For example, sensor data 310 may be used as input into an liquid consumption model 314 to determine a liquid consumption rate and a liquid consumption volume associated with consuming the liquid as described with respect to FIG. 3. In some implementations, determining the consumption rate and the consumption volume may be based on the attributes being used to predict liquid consumption techniques such as sips, sip amounts, gulps, gulp amounts, etc.

In some implementations, determining the consumption volume may be based on the sensor data comprising image data identifying a geometry of a container retaining the liquid. For example, identifying container size (e.g., of a container such as container 256 of FIG. 2D) such as, for example, a glass geometry/diameter and height of a liquid in the container prior and subsequent to a consumption event as described with respect to FIG. 3.

In some implementations, determining the consumption volume may be based on image data identifying a surface level of the liquid with respect to the container prior to said liquid consumption event and a surface level of the liquid with respect to the container subsequent to said liquid consumption event as described with respect to FIG. 3.

At block 406, the method 400 optionally provides feedback to the user based on the consumption rate and consumption volume as described with respect to FIG. 3.

In some implementations, the feedback may be presented to user via a display of the wearable device. In some implementations, wearable device does not have a display. In this instance, the feedback may be presented via another device, such as, inter alia, a mobile device, a tablet, a laptop, etc.

In some implementations, the feedback may summarize information across multiple liquid consumption events.

In some implementations, the feedback may provide a total daily volume of the user consuming a liquid type of the liquid.

In some implementations, the feedback may provide an average consumption rate of the user consuming the liquid type.

In some implementations, the feedback may provide average daily calories of the user consuming the liquid type.

In some implementations, providing the feedback to the user may be further based on different liquid consumption techniques such as sipping, gulping, normal, etc.

In some implementations, providing the feedback to the user may be further based on a liquid type of the liquid. For example, water, tea, soda, etc.

In some implementations, providing the feedback to the user may be further based on a color of the liquid. For example, clear, opaque, etc.

In some implementations, providing the feedback to the user may be further based on a viscosity of the liquid (e.g., Pascal-second).

In some implementations, providing the feedback to the user may be further based on characteristics of the liquid. For example, carbonated, non-carbonate, hot, cold, etc.

In some implementations, providing the feedback to the user may be further based on environmental context associated with the liquid consumption event. For example, a type of environment, a time of day, etc.

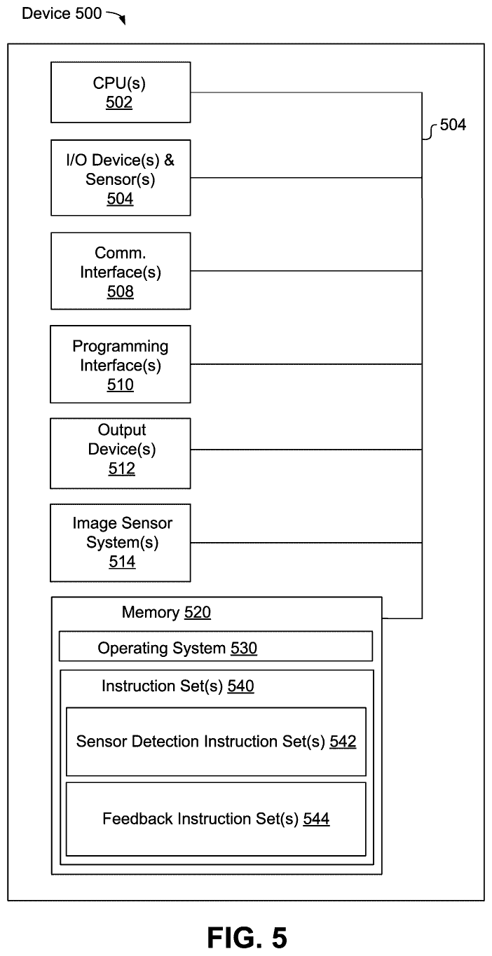

FIG. 5 is a block diagram of an example device 500. Device 500 illustrates an exemplary device configuration for electronic device 105 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 500 includes one or more processing units 502 (e.g., microprocessors, ASICs, FPGAs, GPUs, CPUs, processing cores, and/or the like), one or more input/output (I/O) devices and sensors 504, one or more communication interfaces 508 (e.g., USB, FIREWIRE, THUNDERBOLT, IEEE 802.3x, IEEE 802.11x, IEEE 802.14x, GSM, CDMA, TDMA, GPS, IR, BLUETOOTH, ZIGBEE, SPI, I2C, and/or the like type interface), one or more programming (e.g., I/O) interfaces 510, output devices (e.g., one or more displays) 512, one or more interior and/or exterior facing image sensor systems 514, a memory 520, and one or more communication buses 504 for interconnecting these and various other components.

In some implementations, the one or more communication buses 504 include circuitry that interconnects and controls communications between system components. In some implementations, the one or more I/O devices and sensors 506 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), one or more cameras (e.g., inward facing cameras and outward facing cameras of an HMD), one or more infrared sensors, one or more heat map sensors, and/or the like.

In some implementations, the one or more displays 512 are configured to present a view of a physical environment, a graphical environment, an extended reality environment, etc. to the user. In some implementations, the one or more displays 512 are configured to present content (determined based on a determined user/object location of the user within the physical environment) to the user. In some implementations, the one or more displays 512 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 512 correspond to diffractive, reflective, polarized, holographic, etc. waveguide displays. In one example, the device 500 includes a single display. In another example, the device 500 includes a display for each eye of the user.

In some implementations, the one or more image sensor systems 514 are configured to obtain image data that corresponds to at least a portion of the physical environment 100. For example, the one or more image sensor systems 514 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 514 further include illumination sources that emit light, such as a flash. In various implementations, the one or more image sensor systems 514 further include an on-camera image signal processor (ISP) configured to execute a plurality of processing operations on the image data.

In some implementations, sensor data may be obtained by device(s) (e.g., devices 105 and 110 of FIG. 1) during a scan of a room of a physical environment. The sensor data may include a 3D point cloud and a sequence of 2D images corresponding to captured views of the room during the scan of the room. In some implementations, the sensor data includes image data (e.g., from an RGB camera), depth data (e.g., a depth image from a depth camera), ambient light sensor data (e.g., from an ambient light sensor), and/or motion data from one or more motion sensors (e.g., accelerometers, gyroscopes, IMU, etc.). In some implementations, the sensor data includes visual inertial odometry (VIO) data determined based on image data. The 3D point cloud may provide semantic information about one or more elements of the room. The 3D point cloud may provide information about the positions and appearance of surface portions within the physical environment. In some implementations, the 3D point cloud is obtained over time, e.g., during a scan of the room, and the 3D point cloud may be updated, and updated versions of the 3D point cloud obtained over time. For example, a 3D representation may be obtained (and analyzed/processed) as it is updated/adjusted over time (e.g., as the user scans a room).

In some implementations, sensor data may be positioning information, some implementations include a VIO to determine equivalent odometry information using sequential camera images (e.g., light intensity image data) and motion data (e.g., acquired from the IMU/motion sensor) to estimate the distance traveled. Alternatively, some implementations of the present disclosure may include a simultaneous localization and mapping (SLAM) system (e.g., position sensors). The SLAM system may include a multidimensional (e.g., 3D) laser scanning and range-measuring system that is GPS independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In some implementations, the device 500 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 500 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 500.

The memory 520 includes high-speed random-access memory, such as DRAM, SRAM, DDR RAM, or other random-access solid-state memory devices. In some implementations, the memory 520 includes non-volatile memory, such as one or more magnetic disk storage devices, optical disk storage devices, flash memory devices, or other non-volatile solid-state storage devices. The memory 520 optionally includes one or more storage devices remotely located from the one or more processing units 502. The memory 520 includes a non-transitory computer readable storage medium.

In some implementations, the memory 520 or the non-transitory computer readable storage medium of the memory 520 stores an optional operating system 530 and one or more instruction set(s) 540. The operating system 530 includes procedures for handling various basic system services and for performing hardware dependent tasks. In some implementations, the instruction set(s) 540 include executable software defined by binary information stored in the form of electrical charge. In some implementations, the instruction set(s) 540 are software that is executable by the one or more processing units 502 to carry out one or more of the techniques described herein.

The instruction set(s) 540 includes a sensor detection instruction set 542 and a feedback instruction set 544. The instruction set(s) 540 may be embodied as a single software executable or multiple software executables.

The sensor detection instruction set 542 is configured with instructions executable by a processor to obtain sensor data from a sensor(s) on a wearable device. The sensor data may correspond to attributes (e.g., images, sounds, head movements, vibrations, etc.) of a user while consuming a predetermined amount of liquid with respect to different liquid consumption techniques.

The feedback instruction set 544 is configured with instructions executable by a processor to provide feedback to a user based on a determined liquid consumption rate and consumption volume. For example, feedback may summarize information across multiple liquid consumption events, e.g., providing total daily volume, average consumption rate, average daily calories from liquid, etc.

Although the instruction set(s) 540 are shown as residing on a single device, it should be understood that in other implementations, any combination of the elements may be located in separate computing devices. Moreover, FIG. 5 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a processor of a wearable device:
obtaining sensor data from at least one sensor on the wearable device, the sensor data corresponding to activity of a user wearing the wearable device, the activity corresponding to a liquid being consumed;
based on the sensor data, determining a liquid consumption type associated with the activity of the user; and
based on the sensor data and the liquid consumption type, determining a consumption rate and a consumption volume associated with the activity of the user.

2. The method of claim 1, wherein said determining the consumption rate and the consumption volume comprises inputting the sensor data into a machine learning (ML) model.

3. The method of claim 1, wherein said determining the consumption rate and the consumption volume is based on the attributes being used to predict liquid consumption techniques.

4. The method of claim 1, wherein said determining the consumption volume is based on the sensor data comprising image data identifying a geometry of a container retaining the liquid.

5. The method of claim 4, wherein said determining the consumption volume is further based the image data identifying a surface level of the liquid with respect to the container prior to said liquid consumption event and a surface level of the liquid with respect to the container subsequent to said liquid consumption event.

6. The method of claim 1, wherein the feedback summarizes information across multiple liquid consumption events.

7. The method of claim 6, wherein the feedback provides a total daily volume of the user consuming a liquid type of the liquid.

8. The method of claim 6, wherein the feedback provides an average consumption rate of the user consuming the liquid type and an average daily calories of the user consuming the liquid type.

9. The method of claim 1, wherein said providing the feedback to the user is further based on different liquid consumption techniques.

10. The method of claim 1, wherein said providing the feedback to the user is further based on a liquid type of the liquid.

11. The method of claim 1, wherein said providing the feedback to the user is further based on a color of the liquid.

12. The method of claim 1, wherein said providing the feedback to the user is further based on a viscosity of the liquid.

13. The method of claim 1, wherein said providing the feedback to the user is further based on environmental context associated with the liquid consumption event.

14. The method of claim 1, wherein the attributes comprise audible sounds produced by the user during the liquid consumption event.

15. The method of claim 1, wherein the attributes comprise:
head movements of the user during the liquid consumption even;
vibrations produced from body portion movements of the user during the liquid consumption event; or
biometric attributes of the user during the liquid consumption event.

16. The method of claim 1, wherein the sensor data comprises:
audio data from a microphone;
IMU data; and
audio accelerometer data.

17. The method of claim 1, wherein the consumption type is determined during: (a) a sip while a head of the user is tilted head back; (b) a gulp while the head of the user is tilted head back; (c) a sip with straw; or (d) a gulp with straw.

18. The method of claim 1, further comprising:
providing feedback to the user based on the consumption rate and consumption volume.

19. A wearable device comprising:
a non-transitory computer-readable storage medium;
at least one sensor; and
one or more processors coupled to the non-transitory computer-readable storage medium, wherein the non-transitory computer-readable storage medium comprises program instructions that, when executed on the one or more processors, cause the wearable device to perform operations comprising:
obtaining sensor data from the at least one sensor on the wearable device, the sensor data corresponding to an activity of a user wearing the wearable device, the activity corresponding to a liquid being consumed;
based on the sensor data, determining a liquid consumption type associated with the activity of the user; and
based on the sensor data and the liquid consumption type, determining a consumption rate and a consumption volume associated with the activity of the user.

20. A non-transitory computer-readable storage medium, storing program instructions executable by one or more processors to perform operations comprising:
at a wearable device having a processor and at least one sensor:
obtaining sensor data from the at least one sensor on the wearable device, the sensor data corresponding to an activity of a user wearing the wearable device, the activity corresponding to a liquid being consumed;
based on the sensor data, determining a liquid consumption type associated with the activity of the user; and
based on the sensor data and the liquid consumption type, determining a consumption rate and a consumption volume associated with the activity of the user.
